(19) United States
(12) Patent Application Publication
(10) Pub. No.: US 2005/0203920 A1
(43) Pub. Date: Sep. 15, 2005

(54) Metadata-related mappings in a system

(76) Inventors: Yu Deng, Adelphi, MD (US); Harumi A. Kuno, Cupertino, CA (US); Kevin L. Smathers, Hayward, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/797,266

(22) Filed: Mar. 10, 2004

(51) Int. Cl. G06F 7/00

(52) U.S. Cl. 707/100; 707/1

(57) ABSTRACT

A method and system comprising a processor and storage coupled to the processor are provided. The storage contains elements of metadata belonging to a plurality of schemas. Mappings between the elements of metadata that comprise functional expressions executable by the processor relate the elements of metadata. Methods for validating and updating the mappings when one of the plurality of schemas change are also provided.

### BACKGROUND

An enterprise may employ a collection of distributed metadata systems that store information concerning the enterprise's resources. The term “metadata” refers to machine readable information about data. Each system may be associated with a schema that defines the organization of the metadata stored by the system. The schema may organize the metadata into elements that have relationships with other elements. Unfortunately, the schema may not be capable forming functional and algebraic relationships between elements, including elements from different schemas. Without such relationships, the enterprise may not be able to integrate the metadata systems to provide a cohesive system describing the enterprise's resources.

### BRIEF SUMMARY

In accordance with at least some embodiments of the invention, a system comprises a processor and storage coupled to the processor. The storage contains elements of metadata belonging to a plurality of schemas. Mappings between the elements of metadata that comprise functional expressions executable by the processor relate the elements of metadata.

### BRIEF DESCRIPTION OF THE DRAWINGS

For a detailed description of some embodiments of the invention, reference will now be made to the accompanying drawings in which:

FIG. 1 illustrates a system configured in accordance with embodiments of the invention;

FIG. 2 illustrates an exemplary parameter path in accordance with embodiments of the invention;

FIG. 3 illustrates constructs associated with a virtual property in accordance with various embodiments of the invention;

FIG. 4 illustrates constructs associated with a virtual property in accordance with other embodiments of the invention;

FIGS. 5A and 5B illustrate an exemplary implementation of a dependency chain in accordance with embodiments of the invention;

FIG. 6 illustrates a block diagram of an exemplary query procedure associated with a virtual property in accordance with embodiments of the invention;

FIG. 7 illustrates a block diagram of an exemplary propagation procedure associated with a updated property or domain class in accordance with embodiments of the invention;

FIG. 8 illustrates a block diagram of an exemplary dependency chain generation procedure in accordance with embodiments of the invention;

FIG. 9 illustrates a validated dependency chain in accordance with embodiments of the invention; and

FIG. 10 illustrates an exemplary architecture of a system in accordance with embodiments of the invention.

### NOTATION AND NOMENCLATURE

Certain terms are used throughout the following description and claims to refer to particular system components. As one skilled in the art will appreciate, various companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to.”

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

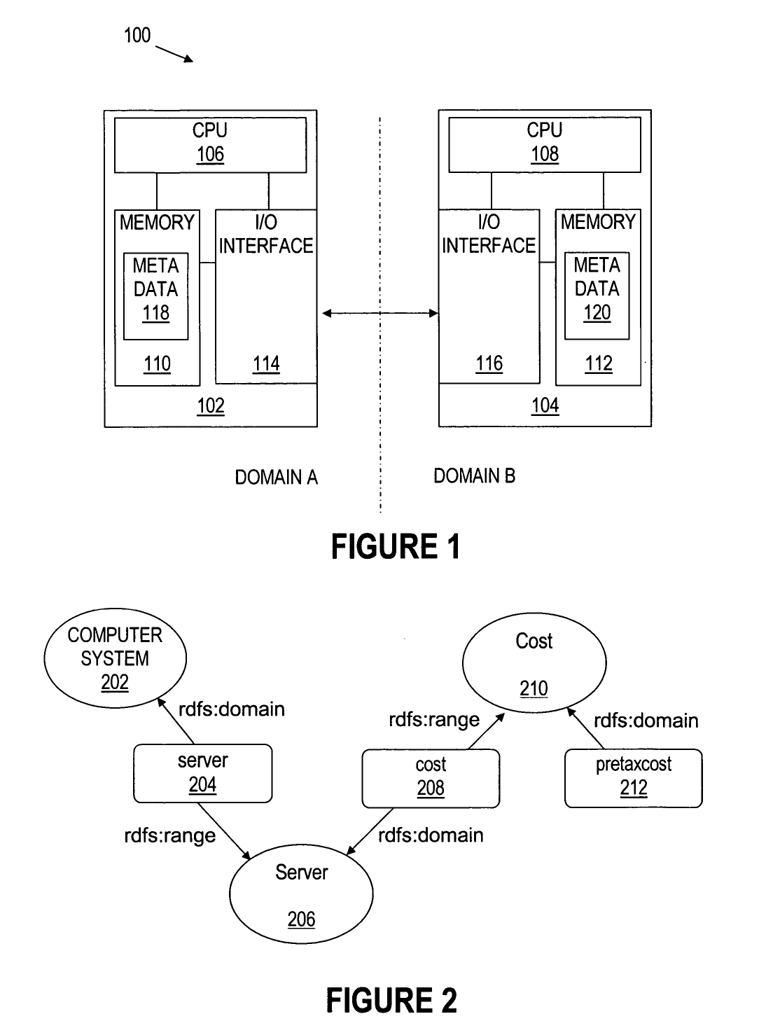

FIG. 1 shows a system 100 configured in accordance with embodiments of the invention. As shown, system 100 comprises one or more computer systems 102 and 104. The computer systems 102 and 104 may be any type of computer system, such as a laptop computer, a personal computer, or stand-alone computer operated as a server. Each computer system 102 and 104 comprises a central processing unit (CPU) 106 and 108, a memory 110 and 112, and an input/output (I/O) interface 114 and 116, respectively. The memories 110 and 112 may comprise any type of volatile or non-volatile memory, such as random access memory (RAM), read-only memory (ROM), and/or a hard drive. The system 100 may be representative of a loosely-coupled metadata system, in which the computer systems 102 and 104 exchange metadata via the I/O interfaces 114 and 116.

Metadata modules 118 and 120 may be stored in the memories 110 and 112, respectively. The metadata modules 118 and 120 may comprise any type of metadata component, such as directories, catalogs, and dictionaries. The metadata modules 118 stored in the memory 110 may operate in domain A, and the metadata modules 120 stored in the memory 112 may operate in domain B.

The domains A and B may be associated with one or more ontologies. Each ontology represents a metadata schema that provides a formal, explicit vocabulary of terms capable of being processed by the CPUs 106 and 108. An ontology is a set of concepts, such as things, events, and relations, that are specified to create an agreed-upon vocabulary for exchanging information. The ontologies may define classes of metadata, class relationships, instances (particular realizations of abstract classes), slot/values (attribute/values), inheritance, constraints, relations between classes, and reasoning tasks for the metadata stored in the memories 110 and 112.

Numerous frameworks, such as resource description framework (RDF), may be utilized to describe and interchange metadata in the system 100. RDF defines a model for describing relationships between metadata in terms of uniquely identified properties and values. Intrinsic to RDF are four object types: resources, literals, properties, and statements.

A resource may represent any stored object that is associated with a universal resource indicator (URI). For example, resources may comprise webpages and individual elements of an extensible markup language (XML) document. A literal may represent any type of atomic value, such as an integer or string. A property may be a special type of resource that represents a specific aspect, characteristic, attribute, or relation used to describe a resource. For example, RDF defines a property rdf:type, which indicates membership in a class. A statement is an ordered triple that associates a specific resource with a named property. For example, a statement may represent the assertion that “The Author of http://www.tomsawyer.com is Mark Twain.” RDF possesses a mechanism for transforming a statement into one or more resources and associated properties.

RDF-Schema (RDFS) may extend RDF with special resources and properties that define class and property constructs. For example, the property rdfs:subPropertyOf may define a transitive subsevsuperset relationship indicating property specialization. In addition, the domain and range of properties may be associated with resources via the constraint properties rdfs:domain and rdfs:range. The rdfs:domain constraint property states that any resource that has a given property is an instance of one or more classes. The rdfs:range constraint property states that the values of a property are instances of one or more classes.

The OWL Web Ontology Language extends XML, RDF, and RDFS with constructs that support inference of implicit relationships. The implicit relationships may be derived from explicitly represented relationships between resources, including relationships between resources from different ontologies. Although at least some embodiments of the invention utilize the OWL framework, the methods and procedures presented are widely applicable to other ontology languages, such as ontology inference layer (OIL), DARPA Agent Markup Language (DAML), and DAML+OIL.

FIG. 2 illustrates an exemplary OWL parameter path, server.cost.pretaxCost. Computer system 202, server 206, and cost 210 may represent classes in an RDFS namespace. Server 204, cost 208, and pretax cost 212 may represent stored properties in the RDFS namespace. One of the range classes of the property server 204 is the class server 206, which has a stored property cost 208.

Embodiments of the invention permit algebraic and functional relationships to be established between resources, including properties, through the use of a special class of properties, referred to as “virtual properties.” Virtual properties are functional mappings that possess values that are derived functionally, rather than stored like the RDF properties previously discussed. Each virtual property is associated with a function that possesses one or more parameters defined in terms of other resources, including other properties. For example, the virtual property total cost may be associated with the function cost+pretax_cost, which may represent the total cost of a component. The resources defined by the exemplary function, namely cost and pretax_cost, are the parameters of the function and may belong to one or several distinct ontologies. When querying a virtual property, an interpreter may access the associated function, retrieve the values of the parameters associated with the function, and calculate a value of the function.

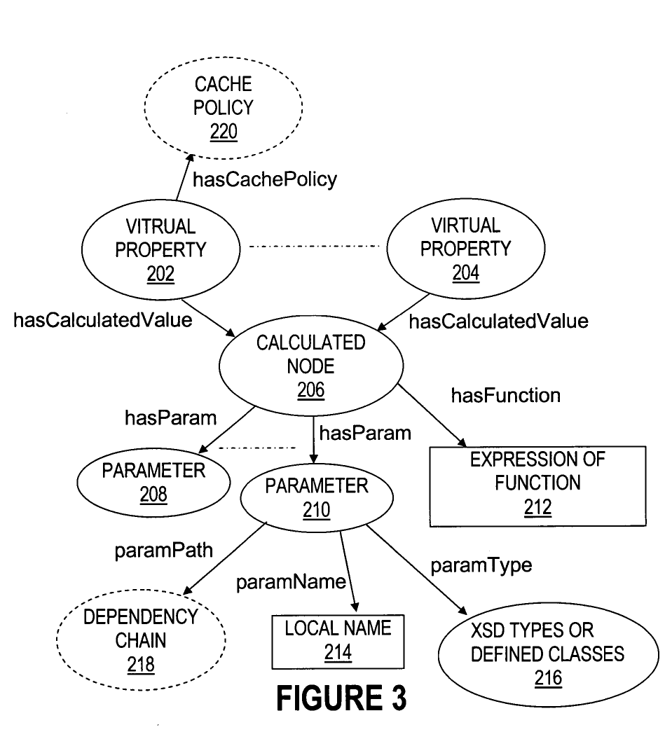

Referring to FIG. 3, the constructs associated with virtual properties are shown in accordance with at least some embodiments of the inventions. As shown, one or more virtual properties 202 and 204 may share a calculated node 206. The calculated node 206 may represent a class of resource that aggregates the parameters and other resources associated with the virtual properties 202 and 204.

Several properties are defined to store relevant characteristics of the virtual properties 202 and 204. A hasCalculatedValue property may represent the relationship between the virtual properties 202 and 204 and the calculated node 206. A hasParam property may represent the relationship between the calculated node 206 and an aggregation path that specifies the one or more parameters 208 and 210 of the function associated with the virtual properties 202 and 204. A hasFunction property may represent the relationship between the calculated node 206 and an expression of the function 212 associated with the virtual properties 202 and 204. The expression of the function 212 may be stored as a string or any other type defined by the OWL framework.

Each parameter 208 and 210 may be associated with a local name and a type through a paramName and a paramType property, respectively. In addition, a paramPath property may represent the relationship between a parameter and a dependency chain. The dependency chain may hold the relationships between the resources in the parameter path of the parameter. Collectively, the dependency chains associated with a calculated node hold the dependent relationships between the function associated with a virtual property and properties upon which the function depends.

Each parameter 208 and 210 may be implemented in the OWL framework as a blank node that aggregates a local name, type, and dependency chain associated with the parameter. Blank nodes are a class of object devoid of associated attributes, possessing neither a URI reference nor a literal. In the RDF abstract syntax, a blank node is a unique node that can be used in one or more RDF statements, but has no globally distinguishing identity. For example, the parameter 210 may be implemented as a blank node that aggregates the local name 214, the type 216, and the dependency chain 218, but does not have a URI reference.

A cache policy 220 optionally may be implemented to cache the value of the calculated node 206. The cache policy 220 may be designated via the hasCachePolicy property. When a query that utilizes the virtual property 202 or 204 is issued, a cached value may be directly accessed and utilized as the result of the function associated with the virtual properties 202 and 204.

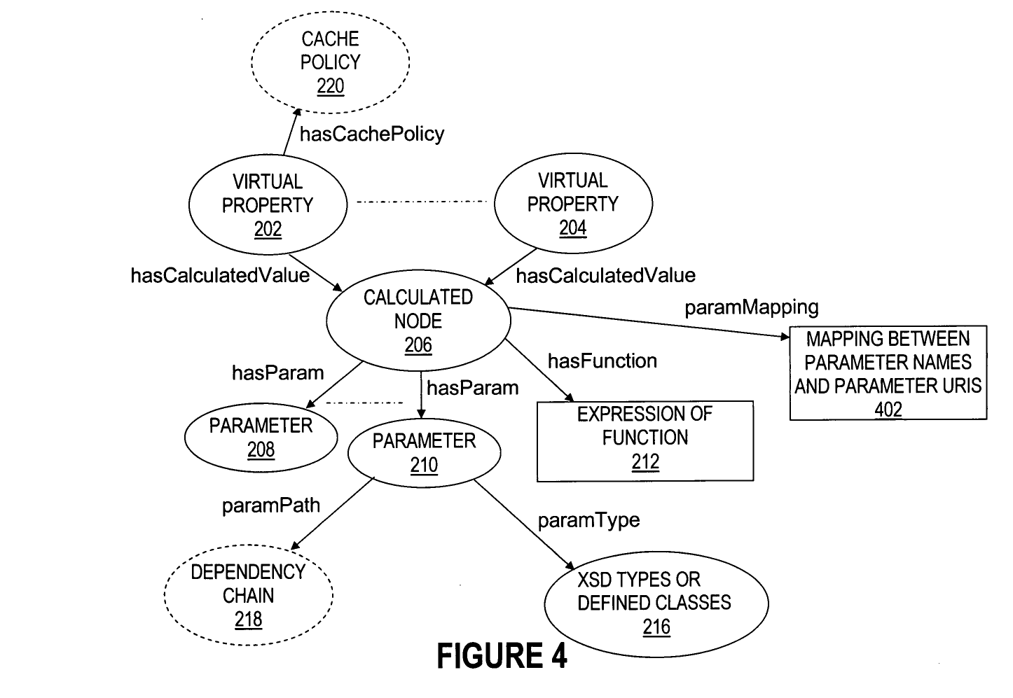

Referring now to FIG. 4, the constructs associated with the virtual properties 202 and 204 are shown in accordance with other embodiments of the inventions. In these other embodiments, the parameters 208 and 210 are implemented as RDF resources, as opposed to blank nodes. An explicit mapping 402 between the parameter URIs and the parameter local names are provided and connected to the calculated node 206 via a paramMapping property.

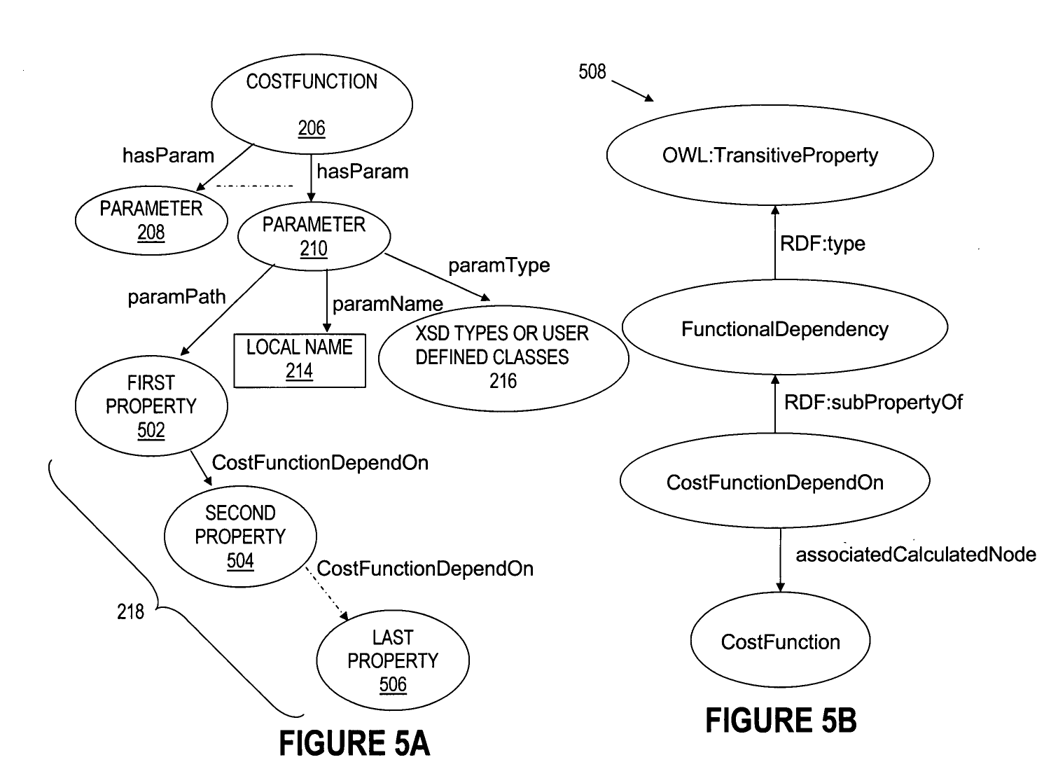

Referring to FIGS. 5A and 5B, an exemplary embodiment of a dependency chain 218 is shown. Although a dependency chain may possess any number of properties, the dependency chain 218 comprises a first property 502, a second property 504, and a last property 506. A CostFunctionDependOn property connects the first property 502, the second property 504, and the last property 506. A FunctionalDependency property may be implemented in the OWL framework via the OWL:TransitiveProperty construct 508. The property CostFunctionDependOn may be a unique sub-property of the FunctionalDependency property. The property associatedCaclulatedNode may link a calculated node CostFunction to the property CostFunctionDependOn, thereby connecting all virtual properties that may be affected by a change to a given class or property associated with a dependency chain. Since CostFunctionDependOn is a unique sub-property, dependency chains with common parameter paths may be distinguished, thereby reducing the number of properties that may need to be verified when a modification of a resource in the dependency chain occurs.

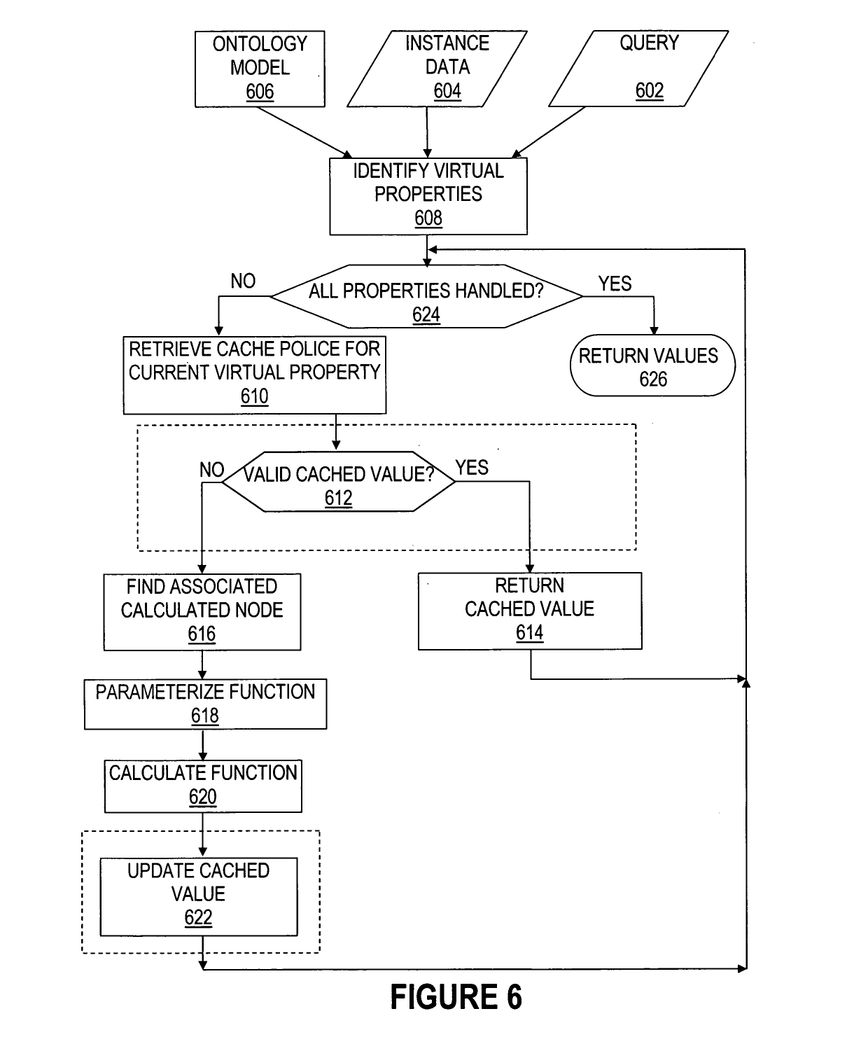

Referring now to FIG. 6, an exemplary procedure for querying a virtual property is shown in accordance with at least some embodiments of the invention. A query 602 may utilize instance data 604 and the ontology model 606 to identify the virtual properties utilized in the query (block 608). The associated optional cache policies may be retrieved via hasCachePolicy property (block 610). If the cache policy indicates a valid cached value (block 612), the cached value is returned (block 614). If the cached value is not valid (block 612) or no caching has been implemented, the associated calculated node is found via the hasCalculatedValue property (block 616). The expression of the function may be retrieved via the hasFunction property, the function may be parameterized utilizing the dependency chains of the parameters (block 618), a value calculated by an interpreter (block 620), and the calculated value optionally may update the cached value (block 622).

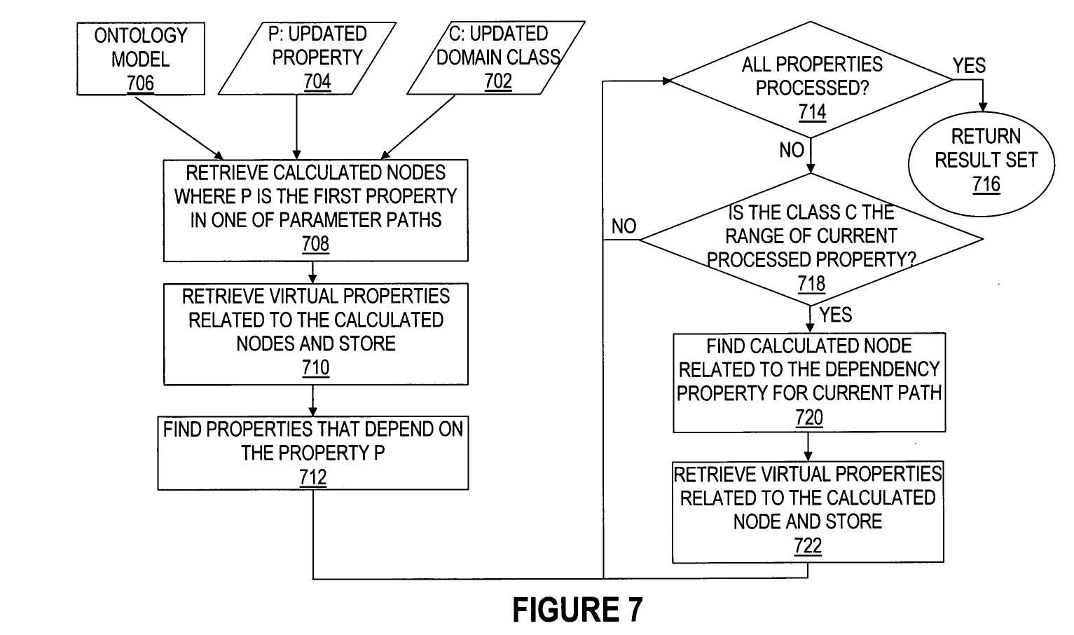

Referring now to FIG. 7, an exemplary block diagram of an update procedure is shown in accordance with embodiments of the invention. When a domain class C is updated (block 702), or a property P is updated (block 704), the ontology model 706 may be utilized to retrieved all calculated nodes, cn, that satisfy:
(cn hasParam ?pm) AND (?pm paramPath P) (1)
where P represents the updated property and ?pm represents a parameter (block 708). For each cn retrieved, all virtual properties that have cn as the calculated function may be stored into a result set (block 710). All properties, ?p, may be found that satisfy the statement:
?p x P (2)
where P represents the updated property and x is a unique subproperty of the predefined property FunctionalDependency, as previously discussed (block 712). If all found properties have been processed (block 714), the result set may be return (block 716). If all found properties have not been processed, the domain class is checked to determine if the class C is the range of the current property ?p(block 718). If the class is correct, the calculated node that satisfies:
x associatedCalculatedNode cn (3)
may be found (block 720). All virtual properties that have cn as their calculated node may be retrieved and stored in the result set (block 722), and the next property may be processed (block 714). The updated property and domain class may be applied to all virtual properties in the result set.

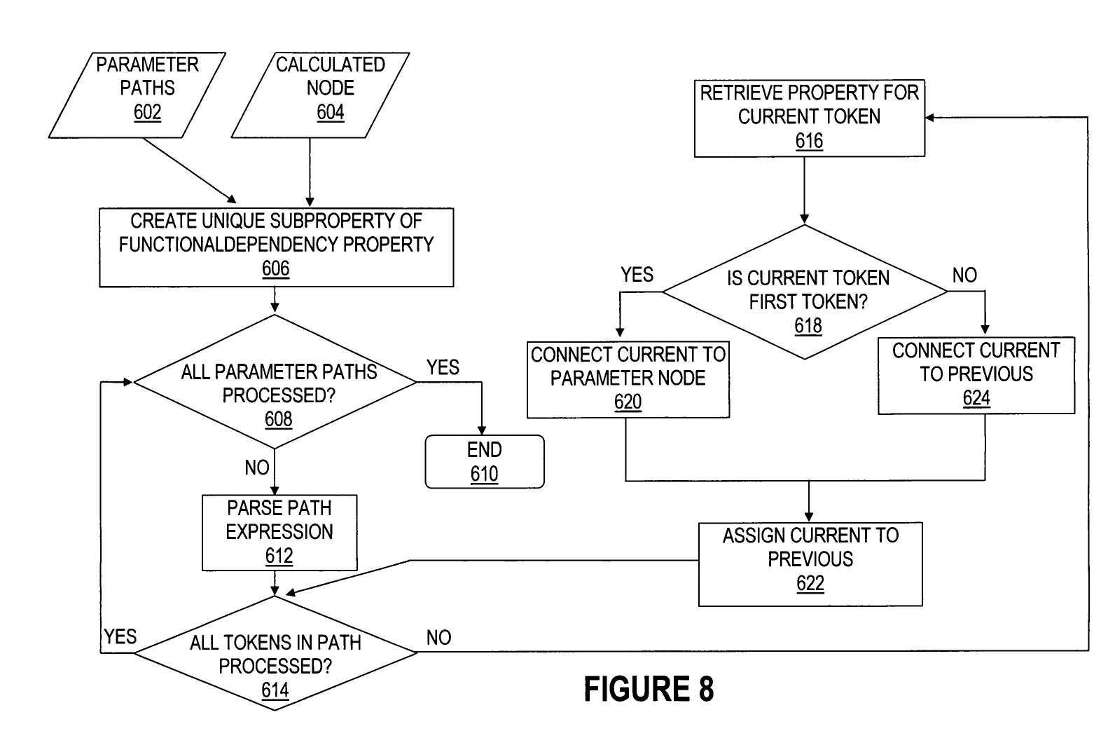

Referring now to FIG. 8, a block diagram of a procedure that generates and initializes a dependency chain is shown. One or more parameter paths 602 that are associated with a calculated node 604 are used to create a unique subproperty of FunctionalDependency for the calculated node 604 (block 606). As previously mentioned, the FunctionalDependency property may be implemented via a sub-property as shown in the OWL:TransitiveProperty construct 508 (FIG. 5). If all parameter paths have been processed (block 608), the procedure ends (block 610). If one or more parameter paths have not been processed, the expression of the next parameter path is parsed (block 612). If all tokens in the parsed parameter path have been processed (block 614), the next parameter path may be processed (block 608). If all tokens have not been processed, the property associated with the current token is retrieved (block 616). If the current token is the first token in the parameter path (block 618), the property associated with the token is connected to the calculated node 604 via the paramPath property (block 620), and the current token is temporarily stored in a variable (block 622). The next token may be now processed (block 614).

If the current token is not the first token (block 618), the current property associated with the token is connected to the previous property via the subproperty of FunctionalDependency (block 624), and the current token is temporarily stored for the next token (block 622). The procedure ends (block 610) when all tokens (block 614) and all parameter paths (block 608) have been processed.

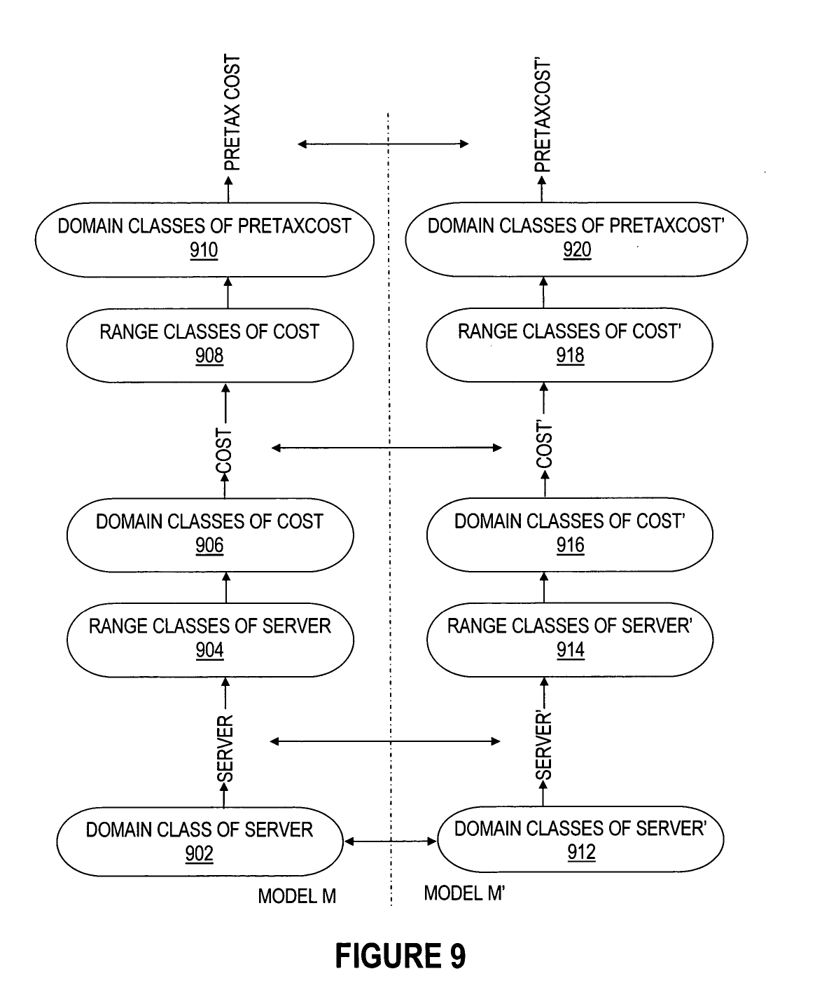

Referring now to FIG. 9, an exemplary procedure that validates two dependency chains associated with distinct ontology models is shown. The dependency chain server.cos.pretaxCost is shown on the left hand side of FIG. 9, and the dependency chain server′.cost′.pretaxCost′ is shown on the right hand side of FIG. 9. The dependency chain server.cost.pretaxCost may be associated with a domain class of server 902, range classes of server 904, domain classes of cost 906, range classes of cost 908, and domain classes of pretaxcost 910. The dependency chain server′.cost′.pretaxCost′ may be associated with domain classes of server′ 912, range classes of server′ 914, domain classes of cost′ 916, range classes of cost′ 918, and domain classes of pretaxcost′ 920. The dependency chain server.cost.pretaxCost may belong to model M, and the dependency chain server′.cost′.pretaxCost′ may belong to model M′.

Given a dependency chain p₁, p₂, . . . , pₙ in a model M, a mapped dependency chain p′₁, p′₂, . . . , p′ₙ in a different model M′ may be validated if (1) given the domain class D₁ of p₁, a mapped class D′₁ in M′ is a domain class of p′₁; (2) p′₂, p′₃, . . . , p′ₙ are mapped properties of p₂, p₃, . . . , pₙ respectively; and (3) a range class of p′ᵢ where i=1, 2, . . . , n−1 is a domain class of p′ᵢ₊₁. If the validation is successful, the dependency chain p₁, p₂, . . . , pₙ in the model M may be validated and successfully mapped to the dependency chain p′₁, p′₂, . . . , p′ₙ in model M′.

As shown in FIG. 9, server′, cost′, and pretaxcost′ are mapped by server, cost, and pretaxcost. One domain class of server′ 912 is mapped by a domain class of server 902, one of the range classes of server′ 914 is a domain class of cost′ 916, and one of the range classes of cost′ 918 is a domain class of pretaxcost′ 920. Thus, server′.cost′.pretaxCost′ is a validated dependency chain mapped by server.cost.pretaxCost.

In a loosely-coupled system, such as utility data center, the instance data schemas may be different from the abstract resource schemas. When querying on the values of virtual properties, as illustrated in FIG. 6, the functions may need to be parameterized (block 618) before invoking the calculation (block 620) so that values can be retrieved from the instance data for all the parameters, including parameter paths. The validation of dependency chains (parameter paths) facilitates the acquisition of the mappings for parameter paths from instance data models, and thus facilitates the acquisition of the values for the parameters from instance data.

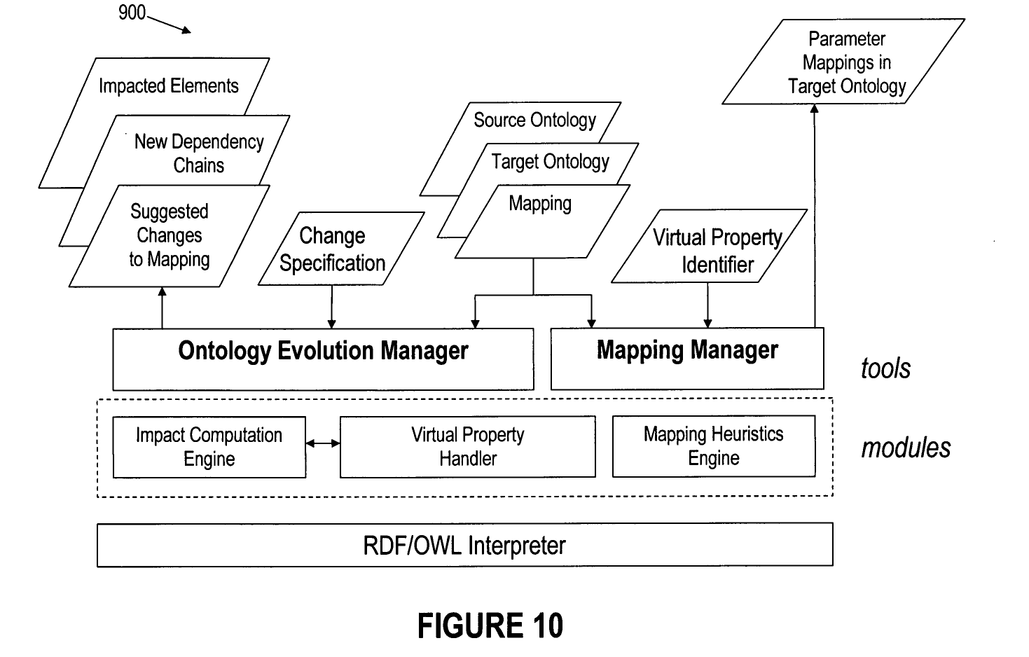

An exemplary architecture 900 of a system in accordance with embodiments of the invention is shown in FIG. 10. As shown, the architecture 900 comprises two tools, a ontology evolution manager and a mapping manager, that are implemented via three modules, an impact computation engine, a virtual property handler, and a mapping heuristics engine. The architecture 900 is implemented over the RDF/OWL interpreter.

Both the ontology evolution manager and the mapping manager utilize as inputs a source ontology, a destination or target ontology, and a mapping between the source and target ontologies. The ontology evolution manager takes as an additional input a specification of a proposed change to the source ontology, and returns as output a set of elements that are potentially impacted by the proposed change, a set of new dependency chains (based on the proposed change), and a set of suggested changes to the mapping. The mapping manager returns the set of parameter mappings in the target ontology.

Given a source ontology, a mapping to a target ontology, and a change specification to the source ontology, the ontology evolution manager may utilize all three modules to maintain the ontologies. The ontology evolution manager may first send the source ontology and the mapping to the target ontology via the OWL interpreter, which returns the OWL model of the source ontology and its associated mapping. The ontology evolution manager may then sends the OWL model and the change specification to the impact computation engine, which parses the change specification and identifies impacted elements of metadata from the source ontology. The impact computation engine may call the virtual property handler to identify impacted virtual properties (virtual properties whose parameters involve impacted elements), and return the impacted virtual properties and new dependency chains to the ontology evolution manager. The ontology evolution manager may add facts about the impacted virtual properties, such as noting which parameters of which virtual properties are potentially impacted by the change, as well as the new dependency chains, to the OWL model and send, along with the change specification, the extended OWL model to the mapping heuristics engine. The mapping heuristics engine may apply predefined heuristics to suggest changes to the mapping, and return the suggest changes to the ontology evolution manager.

Given a source ontology, a mapping to a target ontology, and a virtual property in the source ontology, the mapping manager may utilize the virtual property handler to map the parameters of a virtual property to the target ontology. The procedure may start by the mapping manager sending the source ontology and mapping to the target ontology via the OWL interpreter, which returns OWL model of the source ontology and associated mapping. The mapping manager may then send the OWL model and the virtual property to the virtual property handler. For each parameter to the virtual property, the virtual property handler may identify the elements of the parameter path. For each element of each parameter path that connects to the virtual property, the virtual property handler queries the mapping manager for the mapping of the element in the target ontology. The virtual property handler may then construct new parameter paths in the target ontology, and return the newly constructed parameter paths to the mapping manager.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

1. A system, comprising:
a processor;
storage coupled to the processor and containing elements of metadata belonging to a plurality of schemas; and
mappings between the elements of metadata, each mapping being expressed as metadata and comprising a processor executable functional expression that relates the elements of metadata together.

2. The system of claim 1 wherein the elements of metadata comprise processor readable objects selected from the group consisting of resources, properties, and literals.

3. The system of claim 1 wherein the metadata comprises processor readable objects selected from the group consisting of dictionaries, catalogs, and directories.

4. The system of claim 1 wherein the functional expressions comprise processor readable parameters that represent a resource that aggregates a name, type, and parameter path.

5. The system of claim 1 wherein the functional expressions comprise processor readable parameters that represent a resource aggregating a type and a parameter path and that is connected to a name through an explicit mapping.

6. The system of claim 1 wherein a value of a previously calculated functional expression is cached in the storage.

7. The system of claim 1 wherein reasoning tasks are defined over the mappings.

8. The system of claim 1 further comprising processor readable dependency chains that define dependent relationships between properties of parameter paths of the functional expressions.

9. The system of claim 8 wherein the dependency chains are constructed using sub-properties of a transitive property that distinguishes dependency chains with common parameter subpaths.

10. The system of claim 8 wherein the dependency chains comprise dependency chains that are validated between the plurality of schemas.

11. A method, comprising:
generating a node to represent a functional relationship between one or more objects of distinct ontologies in a metadata system;
associating an expression of the functional relationship to the node; and
associating one or more parameters of the functional relationship to the node.

12. The method of claim 11 further comprising associating a dependency chain representing the dependent relationships between properties of a parameter path associated with the one or more parameters of the functional relationship.

13. The method of claim 11 wherein associating one or more parameters comprises generating a resource that aggregates a local name, type, and dependency chain.

14. The method of claim 11 wherein associating one or more parameters comprises generating a resource that aggregates a type and a dependency chain and that is associated to a name through an explicit mapping.

15. The method of claim 11 further comprising identifying mappings between dependency chains spanning the distinct ontologies.

16. The method from claim 15 wherein the identifying further comprises utilizing heuristics for suggestions of alternative mappings between dependency chains.

17. The method of claim 15 further comprising maintaining the mappings that span the distinct ontologies when one of the distinct ontologies is modified.

18. A computer readable medium storing a program that, when executed by a processor, causes the processor to:
generate a node to represent a functional relationship between one or more objects of distinct ontologies in a metadata system;
link to the node an expression of the functional relationship; and
link one or more parameters of the functional relationship to the node.

19. The computer readable medium of claim 18 wherein the program further causes the processor to connect a dependency chain representing the dependent relationships between properties of a parameter path.

20. The computer readable medium of claim 18 wherein the program further causes the processor to connect one or more parameters comprising generating a blank node that aggregates a local name, type, and dependency chain.

21. A system, comprising:
a means for executing instructions;
a means for storing elements of metadata belonging to a plurality of schemas; and
a means for mapping the elements of metadata, the means for mapping comprising processor readable functional expressions executable by the means for executing instructions.

22. The system of claim 21 wherein the elements of metadata comprise processor readable objects selected from the group consisting of resources, properties, and literals.

23. The system of claim 21 wherein the functional expressions comprise processor readable parameters representing the elements of metadata, the parameters comprising blank nodes that aggregate a name, type, and parameter path.

24. The system of claim 21 wherein the processor readable functional expressions comprise parameters representing the elements of metadata, the parameters comprising resources that are connected to a name through an explicit mapping.

25. The system of claim 21 wherein a value of a previously calculated functional expression is cached in the means for storing elements of metadata.
